(19) United States
(12) Patent Application Publication
(10) Pub. No.: US 2025/0341833 A1
(43) Pub. Date: Nov. 6, 2025

(54) REMOTE CONTROL APPARATUS AND REMOTE CONTROL SYSTEM

(71) Applicant: Mitsubishi Electric Corporation, Tokyo (JP)

(72) Inventors: Shota KAMEOKA, Tokyo (JP); Yohei HOSOE, Kyoto (JP)

(73) Assignee: Mitsubishi Electric Corporation, Tokyo (JP)

(21) Appl. No.: 18/864,014

(22) PCT Filed: Jul. 6, 2022
(86) PCT No.: PCT/JP2022/026790

§ 371 Date: Nov. 8, 2024

(51) Int. Cl. G05D 1/226; G05D 1/622; G05D 1/693; G05D 101/15; G05D 107/13; G05D 109/10; G05D 111/30

(52) U.S. Cl. CPC G05D 1/226; G05D 1/622; G05D 1/693; G05D 2101/15; G05D 2107/13; G05D 2109/10; G05D 2111/32

(57) ABSTRACT

The present disclosure relates to a remote control apparatus controlling at least one mobile object through a transmission path including at least a network, and the apparatus includes: a transmission latency distribution estimation unit to estimate transmission latency distribution information including a probability distribution of transmission latencies in the transmission path; and an action planning unit to plan a target action of the at least one mobile object, based on the transmission latency distribution information, wherein the transmission latency distribution estimation unit estimates the probability distribution of the transmission latencies, using a transmission latency model based on a mode of the transmission latencies.

### TECHNICAL FIELD

The present disclosure relates to a remote control apparatus for a mobile object, and particularly to a remote control apparatus that considers transmission latencies.

### BACKGROUND ART

Recent years have seen development of remote control apparatuses each implementing autonomous driving or automatic transfer by, for example, providing an operation instruction to a mobile object in a remote location or computing a controlled amount for the mobile object. Examples of such remote control apparatuses include those described in Patent Documents 1 and 2.

Each of the remote control apparatuses typically uses radio communication through, for example, radio waves and a network constructed by the radio communication, as implementation means for transmitting and receiving data between the remote control apparatus and a mobile object. Moreover, technologies for controlling mobile objects have been proposed each of which can reduce discomfort of occupants by, for example, adjusting control gains on the mobile object based on a surrounding risk.

### PRIOR ART DOCUMENT

### Patent Document

Patent Document 1: Japanese Patent No. 6940036
Patent Document 2: Japanese Patent Application Laid-Open No. 2020-50342

### SUMMARY

### Problem to be Solved by the Invention

Although a mobile object needs to take a safe action in consideration of transmission latencies when using a network, the technology disclosed in Patent Document 1 cannot plan an appropriate action according to a state of transmission latencies. Moreover, the technology disclosed in Patent Document 2 does not consider transmission latencies in remotely controlling a mobile object.

The present disclosure has been conceived to solve the problems, and has an object of providing a remote control apparatus that considers transmission latencies in remotely controlling a mobile object.

### Means to Solve the Problem

The remote control apparatus according to the present disclosure is a remote control apparatus controlling at least one mobile object through a transmission path including at least a network, the apparatus including: a transmission latency distribution estimation unit to estimate transmission latency distribution information including a probability distribution of transmission latencies in the transmission path; and an action planning unit to plan a target action of the at least one mobile object, based on the transmission latency distribution information, wherein the transmission latency distribution estimation unit estimates the probability distribution of the transmission latencies, using a transmission latency model based on a mode of the transmission latencies.

### Effects of the Invention

The remote control apparatus according to the present disclosure can remotely control a mobile object with much improved safety, by considering transmission latencies in remotely controlling the mobile object.

### BRIEF DESCRIPTION OF DRAWINGS

FIG. 1 is a block diagram illustrating a configuration of a remote control apparatus and a remote control system in Embodiment 1 according to the present disclosure.

FIG. 2 is a block diagram illustrating a configuration of a first mobile object control unit.

FIG. 3 illustrates an example target path when the first mobile object is a vehicle.

FIG. 4 is a block diagram illustrating a configuration of the first mobile object.

FIG. 5 illustrates an example structure of the first mobile object when the first mobile object is a vehicle.

FIG. 6 illustrates example placement of object information obtainment units,

FIG. 7 illustrates a target path along which the first mobile object avoids a stop object.

FIG. 8 illustrates example placement of an object information obtainment unit and an environment information obtainment unit.

FIG. 9 illustrates an example target speed to be generated by the remote control apparatus in Embodiment 1 according to the present disclosure.

FIG. 10 is a block diagram illustrating an example configuration of a transmission latency distribution estimation unit.

FIG. 11 illustrates an example time series of transmission latencies.

FIG. 12 illustrates a modeled example using the HMM.

FIG. 13 is a block diagram illustrating an example configuration of a mobile object action planning unit.

FIG. 14 schematically illustrates operations of the mobile object action planning unit for changing a target action.

FIG. 15 is a block diagram illustrating an example configuration of the mobile object action planning unit.

FIG. 16 schematically illustrates operations for changing a target action based on a mobile object risk.

FIG. 17 is a block diagram illustrating an example control system that controls the first mobile object under a transmission latency environment including the remote control apparatus in Embodiment 1 according to the present disclosure.

FIG. 18 is a block diagram illustrating a configuration of a remote control apparatus and a remote control system in Embodiment 2 according to the present disclosure.

FIG. 19 is a block diagram illustrating an example configuration of the mobile object action planning unit.

FIG. 20 illustrates a planned action when the first mobile object and the second mobile object pass each other.

FIG. 21 is a block diagram illustrating a configuration of a remote control apparatus and a remote control system in Embodiment 2 according to the present disclosure.

FIG. 22 is a block diagram illustrating an example configuration of the transmission latency distribution estimation unit.

FIG. 23 is a block diagram illustrating an example configuration of the transmission latency distribution estimation unit in a remote control apparatus of Embodiment 4 according to the present disclosure.

FIG. 24 illustrates a hardware configuration that implements a remote control apparatus.

FIG. 25 illustrates a hardware configuration that implements a remote control apparatus.

### DESCRIPTION OF EMBODIMENTS

### Embodiment 1

### [Overall Configuration]

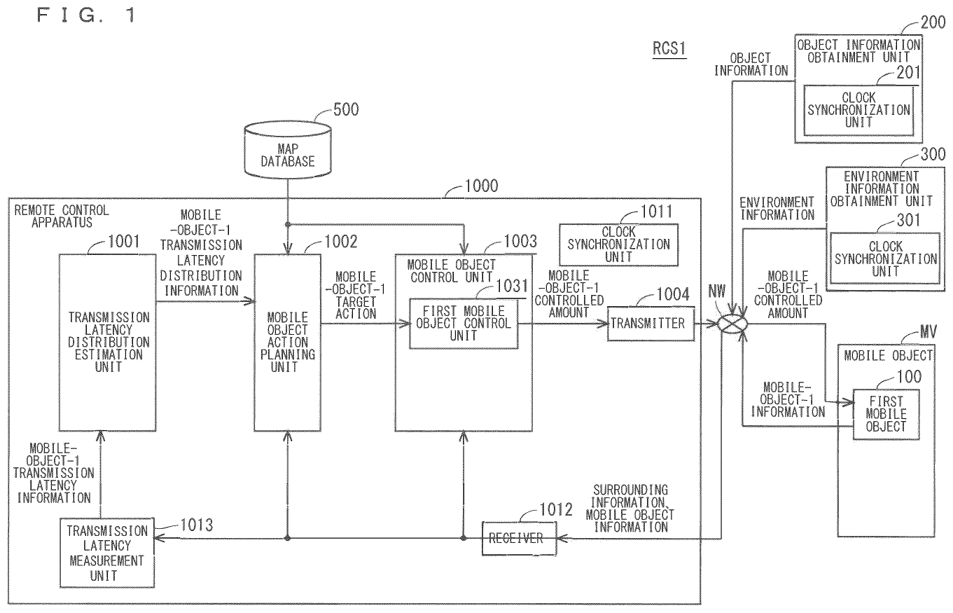

FIG. 1 is a block diagram illustrating an example configuration of a remote control apparatus 1000, and a configuration of a remote control system RCS1 for a mobile object MV to be remotely controlled through a network NW, in Embodiment 1 according to the present disclosure.

As illustrated in FIG. 1, the remote control system RCS1 has the configuration in which the mobile object MV, the remote control apparatus 1000, an object information obtainment unit 200, and an environment information obtainment unit 300 are connected to the network NW.

The network NW enables a plurality of constituent elements to transmit and receive data by mutually connecting the elements through, for example, cables and radio waves. The network NW includes a local area network (LAN), a wide area network (WAN), the Internet, telephone lines, and radio communication. The network NW is not limited to these, and can employ any means that enables transmission and reception of data between a remote control apparatus and a mobile object in a remote location.

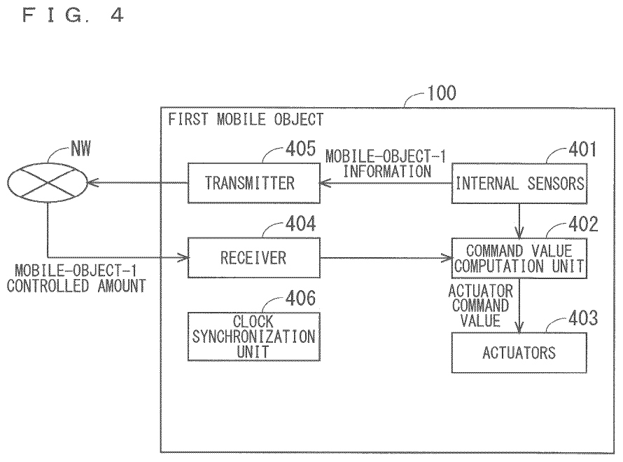

Since a single mobile object is a control target in Embodiment 1, the mobile object MV will be referred to as a first mobile object 100 to be distinguished from a plurality of mobile objects as control targets. The first mobile object 100 moves based on a controlled amount to be transmitted from a transmitter 1004 of the remote control apparatus 1000, and outputs a state quantity of this mobile object which has been detected by the internal sensors (to be described later) including, for example, a speed sensor mounted, as state information on the first mobile object 100, that is, mobile-object-1 information. A configuration of the first mobile object 100 will be described later in detail with reference to FIG. 4.

The object information obtainment unit 200 includes one or more sensors in the vicinity of the first mobile object 100 or to be mounted on the first mobile object 100. The object information obtainment unit 200 is installed in, for example, a traffic light, a utility pole, or an electric lamp at an intersection when the mobile object is an automobile and travels along a road. Furthermore, the object information obtainment unit 200 may be additionally installed on a roadside. For other mobile objects, for example, a mobile object moving indoors, the object information obtainment units may be installed on a ceiling and a wall. The object information obtainment unit 200 obtains, as object information, for example, a position and a speed of an obstacle around the first mobile object 100, such as another vehicle, a bicycle, and a pedestrian. Furthermore, the object information obtainment unit 200 can obtain, as mobile object information, for example, a position and a speed of its own first mobile object 100. Here, the mobile object information is a part of the object information. The object information obtainment unit 200 transmits the mobile object information to a receiver 1012 in the remote control apparatus 1000 through the network NW. When internal sensors are installed in the first mobile object 100, these internal sensors can obtain the mobile object information. Here, the mobile object information corresponds to the mobile-object-1 information. Thus, the mobile object information can be obtained from the object information obtainment unit 200 or the first mobile object 100.

The object information obtainment unit 200 includes a clock synchronization unit 201. The clock synchronization unit 201 has a function of synchronizing the timing of transmitting and receiving data in coordination with a clock synchronization unit in the first mobile object 100 which is not illustrated, a clock synchronization unit 310 in the environment information obtainment unit 300, and a clock synchronization unit 1011 in the remote control apparatus 1000.

Each of the clock synchronization units can perform clock synchronization outdoors, using a Global Navigation Satellite System (GNSS) sensor. Since the GNSS is a clock synchronization system at global levels and relates to a known art, this GNSS can facilitate the clock synchronization. Meanwhile, indoor clock synchronization is possible by accessing a Network Time Protocol (NTP) server installed on the network NW.

The environment information obtainment unit 300 includes one or more sensors to be installed in the vicinity of the first mobile object 100, similarly to the object information obtainment unit 200. The environment information obtainment unit 300 is also installed indoors or outdoors. The environment information obtainment unit 300 obtains environment information on, for example, a traffic light and a stop line. The environment information obtainment unit 300 transmits the environment information to the receiver 1012 in the remote control apparatus 1000 through the network NW. The object information obtainment unit 200 can sometimes obtain the environment information. In all subsequent Embodiments, the object information and the environment information will be collectively referred to as surrounding information. When, for example, a mobile object is a robot, the surrounding information may be solely object information without including environment information. Furthermore, the sensor to be used for the environment information obtainment unit 300 can be mounted on the first mobile object 100.

The environment information obtainment unit 300 includes the clock synchronization unit 301. The clock synchronization unit 301 has a function of synchronizing the timing of transmitting and receiving data in coordination with the clock synchronization unit in the first mobile object 100 which is not illustrated, the clock synchronization unit 201 in the object information obtainment unit 200, and the clock synchronization unit 1011 in the remote control apparatus 1000.

Examples of the sensors to be used in the object information obtainment unit 200 and the environment information obtainment unit 300 include a camera, a light detection and ranging (LiDAR), and a radar.

The camera is installed at a position where a front image, a side image, and a rear image can be captured, and obtains, from the captured images, for example, dividing lines and a position and a speed of an obstacle around the first mobile object 100.

The LIDAR emits a laser beam to the surroundings and detects a time difference from when the laser beam is reflected off from a surrounding object until the beam comes back to detect a position of the object.

The radar emits radar waves to the surroundings and detects the reflected waves to measure a relative distance and a relative speed of a surrounding obstacle with respect to the radar, and outputs the measurement result.

When each obstacle mounts a GNSS sensor that can detect an absolute position of, for example, an obstacle around the first mobile object 100, and when the first mobile object 100 mounts a GNSS sensor and the GNSS sensor can transmit absolute position information to the remote control apparatus 1000 through the network NW, the GNSS enables detection of the object information. In such a case, the object information obtainment unit 200 can be omitted.

A map database 500 stores map data around the first mobile object 100. Although a mobile object action planning unit 1002 and a mobile object control unit are connected to the map database 500 in FIG. 1, besides these, each of the constituent elements in the remote control apparatus 1000 can access the map database 500. When the first mobile object 100 is a vehicle, the map database 500 often includes traveling data, for example, center coordinate information on roads, information on stop lines, information on white lines, and traveling possible regions.

Next, each of the constituent elements of the remote control apparatus 1000 will be described. As illustrated in FIG. 1, the remote control apparatus 1000 includes a transmission latency distribution estimation unit 1001, the mobile object action planning unit 1002, the mobile object control unit 1003, the transmitter 1004, the clock synchronization unit 1011, the receiver 1012, and a transmission latency measurement unit 1013.

The transmission latency measurement unit 1013 measures transmission latencies between the first mobile object 100 and the remote control apparatus 1000, using the clock synchronized by the clock synchronization unit 1011, and outputs, to the transmission latency distribution estimation unit 1001, the transmission latencies as transmission latency information on the first mobile object 100, that is, mobile-object-1 transmission latency information. The transmission latency measurement unit 1013 can obtain the transmission latencies each from a difference between a transmission time included in the mobile-object-1 information output from the first mobile object 100 and a reception time at which the remote control apparatus 1000 has received the mobile-object-1 information.

When a clock synchronization unit is installed in neither the remote control apparatus 1000 nor the first mobile object 100, the transmission latency can be measured in the following manner. In other words, first, the remote control apparatus 1000 transmits a packet to the first mobile object 100, and simultaneously records the time. Upon receipt of the packet, the first mobile object 100 simultaneously transmits the packet to the remote control apparatus 1000. Thus, the remote control apparatus 1000 can obtain the transmission latency from a difference between the reception time of the remote control apparatus 1000 and the transmission time. The transmission latency obtained in such a manner is referred to as a round-trip time (RTT). If the first mobile object 100 similarly records the times, the RTT in view of the first mobile object 100 can be obtained.

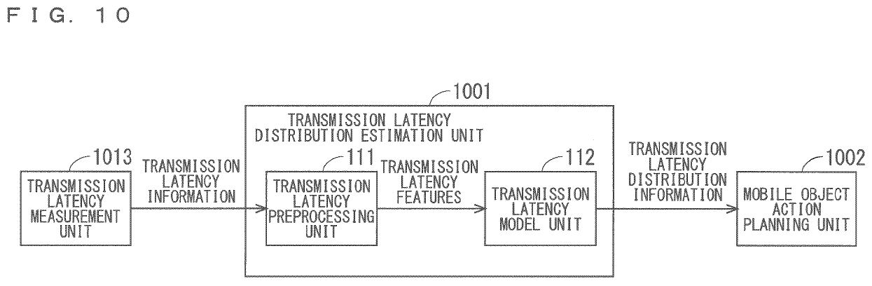

The transmission latency distribution estimation unit 1001 outputs transmission latency distribution information on the first mobile object 100, that is, mobile-object-1 transmission latency distribution information, using the transmission latency information from the transmission latency measurement unit 1013. The transmission latency distribution information is information to be estimated based on a transmission latency model such as a mode of transmission latencies, in addition to a probability distribution of transmission latencies. The configuration and operations of the transmission latency distribution estimation unit 1001 will be described later with reference to FIG. 10.

The mobile object action planning unit 1002 plans an action of the first mobile object 100, that is, deceleration, avoiding an obstacle, stopping, changing a lane, pulling over to a side of a road, or an emergency evasive maneuver, using the map data around the first mobile object 100 which has been obtained from the map database 500, and the object information output from the object information obtainment unit 200, the environment information output from the environment information obtainment unit 300, and the mobile-object-1 information output from the first mobile object 100 all of which have been obtained through the network NW, and the mobile-object-1 transmission latency distribution information output from the transmission latency distribution estimation unit 1001, and outputs the action as a target action of the first mobile object 100, that is, a mobile-object-1 target action. A typical planned action is known from Japanese Patent No, 6908211 that discloses an action planning device. Japanese Patent No. 6908211 discloses a technology for determining an action using scene information on a scene in which a mobile object exists. This disclosure is characterized by planning an action using transmission latency information such that the action is applicable to remotely controlling the mobile object.

The mobile object control unit 1003 includes a first mobile object control unit 1031. The first mobile object control unit 1031 computes a controlled amount for allowing the first mobile object 100 to follow a target trajectory, based on the mobile object information obtained from the network NW through the receiver 1012 and the mobile-object-1 target action obtained from the mobile object action planning unit 1002. When the first mobile object 100 is a vehicle, the controlled amount is, for example, a target steering amount and a target amount of acceleration or deceleration. The first mobile object control unit 1031 outputs the controlled amount to the network NW through the transmitter 1004 as a mobile-object-1 controlled amount.

The remote control apparatus 1000 including the mobile object control unit 1003 can complete the control of the first mobile object 100 according to a planned action.

### [Mobile Object Control Unit]

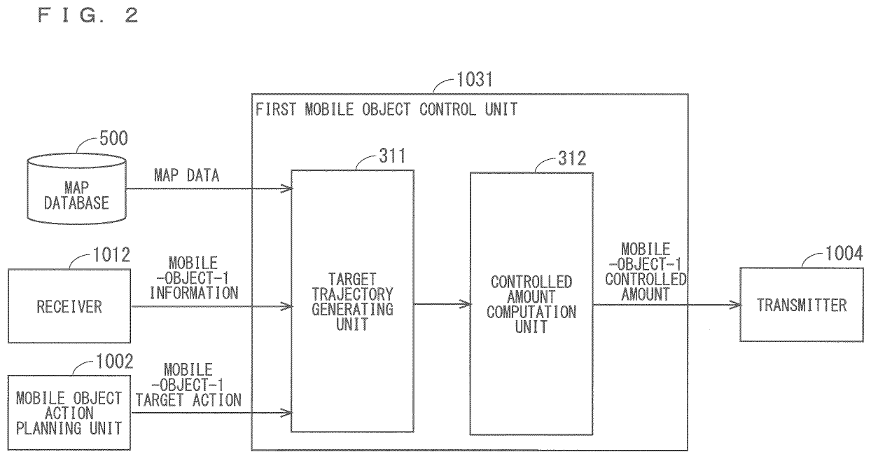

Next, the first mobile object control unit 1031 of the mobile object control unit 1003 will be described with reference to FIG. 2. FIG. 2 is a block diagram illustrating a configuration of the first mobile object control unit 1031.

As illustrated in FIG. 2, the first mobile object control unit 1031 includes a target trajectory generating unit 311 and a controlled amount computation unit 312.

The target trajectory generating unit 311 generates a target trajectory through which the first mobile object 100 achieves a target action, based on the map data around the first mobile object 100 which has been obtained from the map database 500, the mobile-object-1 information obtained from the network NW through the receiver 1012, and the mobile-object-1 target action obtained from the mobile object action planning unit 1002.

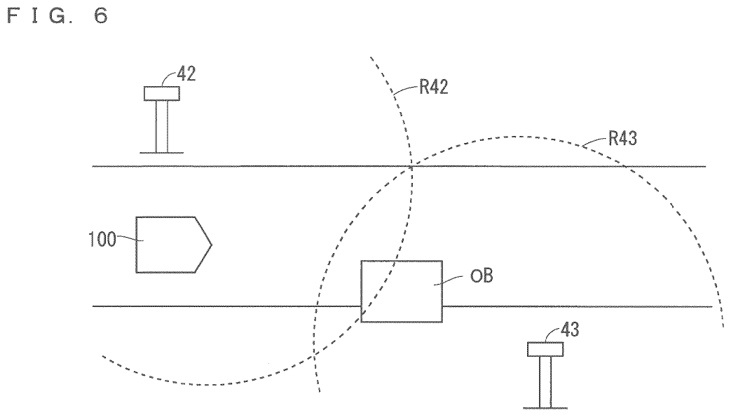

For example, when the target action is “to stop at a position 5 M ahead”, the target trajectory generating unit 311 generates a trajectory for allowing the first mobile object 100 to stop at a position 5 M ahead, that is, a sequence of a target path and a target speed. The target trajectory will be exemplified with reference to FIGS. 6 to 9 later.

The controlled amount computation unit 312 computes a controlled amount for allowing the first mobile object 100 to follow the target trajectory output from the target trajectory generating unit 311.

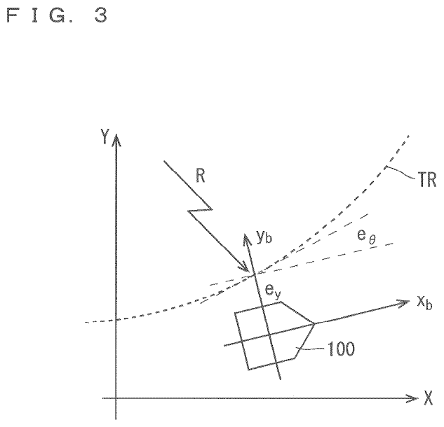

FIG. 3 illustrates a target path TR when the first mobile object 100 is a vehicle, that is, an example sequence of positions in a target trajectory. The target path TR is represented by an absolute coordinate system with X- and Y-axes. e_{y} and e_{θ} denote a lateral deviation and an angle of deviation, respectively, of the first mobile object 100 with respect to the target path TR.

When the target path TR as illustrated in FIG. 3 is given, the controlled amount computation unit 312 computes a controlled amount of the first mobile object 100, that is, a steering angle herein so that the first mobile object 100 follows the target path TR. When the target trajectory includes a sequence of target speeds, the controlled amount computation unit 312 computes controlled amounts for controlling an accelerator and a brake so that the first mobile object 100 travels at the target speeds.

The target trajectory generating unit 311 and the controlled amount computation unit 312 can be simultaneously executed by using, for example, model predictive control. The model predictive control can simultaneously calculate a target trajectory and a controlled amount through sequential optimization, using a model that predicts behaviors of a mobile object (an equation of state) and an evaluation function. Since optimization is performed in the sequential optimization while predicting a state of the mobile object at regular time intervals (horizons) in the future, for example, a position and a speed, the optimization is referred to as the model predictive control. The controlled amount in each of the horizons is optimized in the model predictive control. The optimal trajectory of the mobile object in the horizon can be calculated using the controlled amount, and can be used as a target trajectory. In other words, the target trajectory and the controlled amount can be simultaneously computed.

Furthermore, the mobile object control unit 1003 can compute a controlled amount, using the mobile-object-1 transmission latency distribution information output by the transmission latency distribution estimation unit 1001. This method is known from Japanese Patent No. 6940036.

The first mobile object 100 can include a mobile object control unit. In other words, the remote control apparatus 1000 transmits only a target action to the first mobile object 100, Then, the first mobile object 100 generates a target trajectory, and computes a controlled amount, for example, a target steering angle, based on the target trajectory, so that the first mobile object 100 can be controlled based on the controlled amount. Thereby, the first mobile object 100 can be controlled by its own first mobile object 100 according to a planned action.

### [Mobile Object]

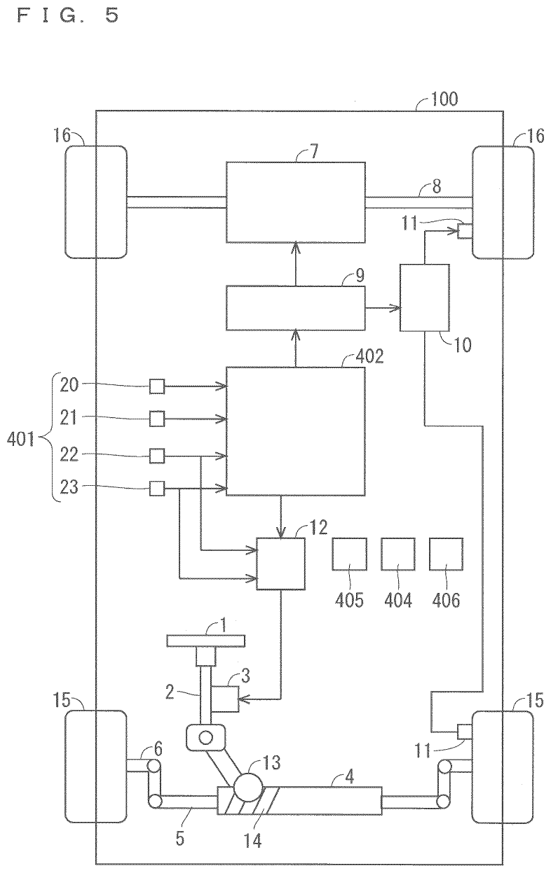

Next, a configuration of the first mobile object 100 will be described with reference to FIGS. 4 and 5. FIG. 4 is a block diagram illustrating the configuration of the first mobile object 100. As illustrated in FIG. 4, the first mobile object 100 includes internal sensors 401, a command value computation unit 402, actuators 403, a receiver 404, a transmitter 405, and a clock synchronization unit 406.

The internal sensors 401 detect internal information on the first mobile object 100 from, for example, an inertial measurement unit (IMU) sensor, a speed sensor, an acceleration sensor, a steering angle sensor, and a steering torque sensor, and output the internal information as the mobile-object-1 information to input the internal information into the network NW through the transmitter 405.

The command value computation unit 402 obtains the mobile-object-1 controlled amount computed by the mobile object control unit 1003 of the remote control apparatus 1000, through the receiver 404, and performs computation of transforming the mobile-object-1 controlled amount into an actuator command value that can be input into the actuators 403. The command value computation unit 402, for example, transforms a target steering angle into a control current value of an electric power steering (EPS). The actuators 403 include a motor that actually operates the first mobile object 100.

The clock synchronization unit 406 has a function of synchronizing the timing of transmitting and receiving data in coordination with the clock synchronization unit 201 in the object information obtainment unit 200, the clock synchronization unit 310 in the environment information obtainment unit 300, and the clock synchronization unit 1011 in the remote control apparatus 1000.

FIG. 5 illustrates an example structure of the first mobile object 100 when the first mobile object 100 is a vehicle. A steering wheel 1 installed for a driver, that is, an operator to operate the vehicle engages with a steering axle 2. The steering axle 2 engages with a pinion shaft 13 of a rack-and-pinion mechanism 4. A rack shaft 14 of the rack-and-pinion mechanism 4 is reciprocally movable according to rotation of the pinion shaft 13. Front knuckles 6 are connected to both ends of the rack shaft 14 through tie rods 5. The front knuckles 6 rotatably support front wheels 15 as steering tires, and are supported by a car frame so that the front wheels 15 are flexibly steerable.

Thus, a torque generated by the driver through operating the steering wheel 1 causes the steering axle 2 to rotate. The rack-and-pinion mechanism 4 moves the rack shaft 14 in a lateral direction according to rotation of the steering axle 2. Movement of the rack shaft 14 rotates each of the front knuckles 6 with respect to a kingpin axis that is not illustrated, and accordingly steers the front wheels 15 in the lateral direction. Thus, operating the steering wheel 1 by the driver when the vehicle moves forward and backward can vary an amount of lateral movement of the vehicle.

Unmanned mobile objects such as a fully autonomous vehicle and a drone do not need a constituent element for operations of a driver, such as a steering wheel.

For example, a vehicle speed sensor 20, an IMU sensor 21, a steering angle sensor 22, and a steering torque sensor 23 are installed in the first mobile object 100 as the internal sensors 401 each of which recognizes a moving state of the first mobile object 100. A detection value of each of the internal sensors 401 is input to the command value computation unit 402.

As described with reference to FIG. 4, the command value computation unit 402 performs computation of transforming the mobile-object-1 controlled amount into an actuator command value that can be input into each of the actuators 403, and inputs the actuator command value into each of an acceleration/deceleration control device 9 and a steering control device 12.

An electric motor 3 for implementing a lateral motion of the first mobile object 100, and actuators for controlling forward and backward motions of the first mobile object 100, such as a vehicle driving device 7 and a brake control device 10 are installed in the first mobile object 100.

The acceleration/deceleration control device 9 controls the vehicle driving device 7 and the brake control device 10. The steering control device 12 controls the electric motor 3.

The electric motor 3 typically includes a motor and a gear, and imparts a torque to the steering axle 2 so that the steering axle 2 can be flexibly rotated. In other words, the electric motor 3 can flexibly steer the front wheels 15, independently from operating the steering wheel by the driver.

The vehicle driving device 7 is an actuator for driving the first mobile object 100 in a forward and backward direction. The vehicle driving device 7 rotates the front wheels 15 and rear wheels 16, by using, for example, driving force obtained from a driving source such as an engine or a motor, through a transmission and a shaft that are not illustrated. This enables the vehicle driving device 7 to flexibly control the driving force of the first mobile object 100.

The brake control device 10 is an actuator for braking the first mobile object 100, and controls a brake amount of a brake 11 installed at each of the front wheels 15 and the rear wheels 16 of the first mobile object 100. A typical brake generates braking force by pressing a pad against a disc rotor that rotates together with the front wheels 15 and the rear wheels 16, using hydraulic pressure.

The internal sensors and the other devices configure a network using, for example, a controller area network (CAN) or a local area network (LAN) in the first mobile object 100. Each of the devices in the first mobile object 100 in FIG. 5 can obtain information through this network. The internal sensors can mutually transmit and receive data through the network. Even when the first mobile object is not a vehicle, the first mobile object has the same configuration including actuators, internal sensors, and a command value computation unit.

### [Object Information Obtainment Units and Target Trajectory Generating Unit]

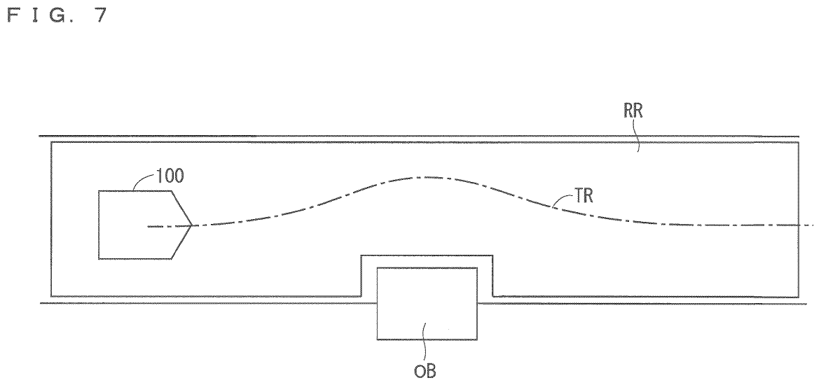

Next, example placement of the object information obtainment units 200 and an example target trajectory to be generated by the remote control apparatus 1000 will be described with reference to FIGS. 6 and 7. FIG. 6 illustrates a case where external sensors 42 and 43 are placed on a side of a road along which the first mobile object 100 moves, as the example placement of the object information obtainment units 200. A stop object OB exists ahead of the first mobile object 100. Detection ranges of the external sensor 42 and the external sensor 43 are a range R42 and a range R43, respectively.

Examples of the external sensors 42 and 43 include a camera, a LIDAR, a radar, a sonar, and an infrared camera. The external sensors 42 and 43 detect positions and speeds of, for example, the first mobile object 100 and other objects. Although the external sensors 42 and 43 are placed on the side of the road in FIG. 6, the external sensors 42 and 43 can be mounted on the first mobile object 100.

FIG. 7 illustrates the target path TR for generating a target trajectory along which the first mobile object 100 avoids the stop object OB, when the stop object OB exists ahead of the first mobile object 100.

The external sensor 42 in FIG. 6 detects a relative position and a relative speed of the first mobile object 100 with respect to the external sensor 42. Furthermore, the external sensors 42 and 43 detect relative positions and relative speeds of the stop object OB with respect to the external sensors 42 and 43. Each of the object information obtainment units 200 transforms information on the relative positions and the relative speeds of such a mobile object and the stop object OB with respect to the external sensors 42 and 43 into information on a relative position and a relative speed of the stop object OB when viewed from the first mobile object 100. Alternatively, the object information obtainment unit 200 calculates a relative position and a relative speed of the stop object OB with respect to the first mobile object 100 by transforming information on the relative positions and the relative speeds of the first mobile object 100 and the stop object OB with respect to the external sensors 42 and 43 into a coordinate system unified between the first mobile object 100 and the stop object OB, for example, a geographical coordinate system to be used in the GNSS.

Upon receipt of the mobile-object-1 target action, such as “avoid an object” from the mobile object action planning unit 1002 of the remote control apparatus 1000, the target trajectory generating unit 311 in the first mobile object control unit 1031 generates the target path TR as illustrated in FIG. 7, based on these pieces of information. This target path TR is a path along which the first mobile object 100 avoids the stop object OB, and a path along which the first mobile object 100 moves within a movable region RR. Although there is no illustration, the target trajectory generating unit 311 also generates a target speed of the first mobile object 100, and combines the target speed with the target path TR to be used as a target trajectory.

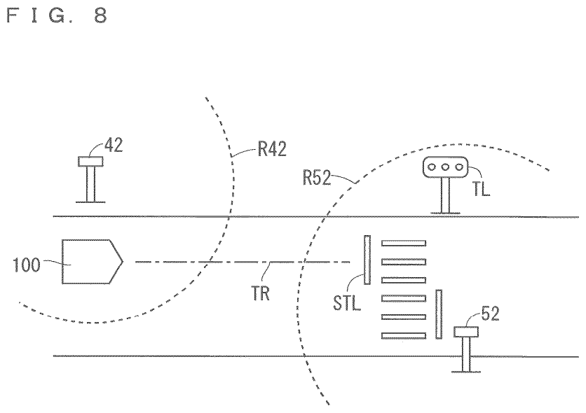

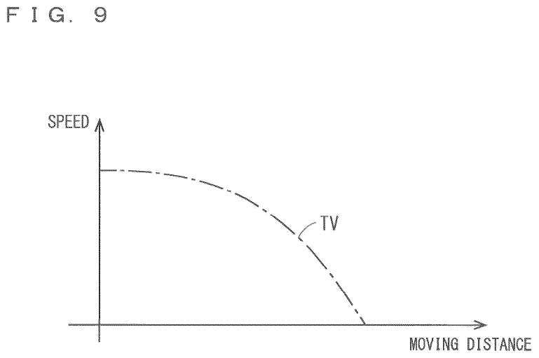

FIG. 8 illustrates example placement of the object information obtainment unit 200 and the environment information obtainment unit 300. FIG. 9 illustrates an example target speed to be generated by the remote control apparatus 1000.

FIG. 8 illustrates that the external sensor 42 is placed on a side of a road along which the first mobile object 100 moves as example placement of the object information obtainment unit 200 when a stop line STL and a traffic light TL are installed ahead of the first mobile object 100 and that an external sensor 52 is placed at a position at which the external sensor 52 can detect the stop line STL and an emission color of and the traffic light TL as example placement of the environment information obtainment unit 300. Detection ranges of the external sensor 42 and the external sensor 52 are a range R42 and a range R52, respectively.

The external sensor 42 in FIG. 8 detects a relative position and a relative speed of the first mobile object 100 with respect to the external sensor 42. The external sensor 52 detects relative positions of the stop line STL and the traffic light TL with respect to the external sensor 52.

The external sensor 42 in FIG. 8 detects a relative position and a relative speed of the first mobile object 100 with respect to the external sensor 42. The external sensor 52 detects the stop line STL and the emission color of the traffic light TL.

In FIG. 9, the horizontal axis represents a moving distance when the first mobile object 100 moves toward the stop line STL, and the vertical axis represents a speed of the first mobile object 100.

When the external sensor 52 detects the traffic light TL as a red light and the mobile object action planning unit 1002 of the remote control apparatus 1000 inputs the mobile-object-1 target action, such as “stop at the stop line because of the red light”, the target trajectory generating unit 311 in the first mobile object control unit 1031 generates the target path TR for stopping at the stop line STL indicated by alternate long and short dash lines in FIG. 8, and sets a target speed TV indicated by alternate long and short dash lines in FIG. 9, based on these pieces of information. This target speed TV is a speed obtained by gradually reducing the speed of the first mobile object 100 to become zero at the stop line STL. The target trajectory generating unit 311 generates a target trajectory (a stop trajectory) obtained by combining the target path with the target speed.

### [Transmission Latency Distribution Estimation Unit]

FIG. 10 is a block diagram illustrating an example configuration of the transmission latency distribution estimation unit 1001, In this example, the transmission latency distribution estimation unit 1001 includes a transmission latency preprocessing unit 111 and a transmission latency model unit 112.

The transmission latency preprocessing unit 111 has a function of transforming the transmission latency information from the transmission latency measurement unit 1013 into transmission latency features to be referred to by the transmission latency model unit 112. Examples of the transmission latency features can include an average value, variance, and a higher moment of a transmission latency distribution within a predefined time segment. Alternatively, the maximum value and the minimum value of transmission latencies within a time segment can be used as transmission latency features.

The transmission latency model unit 112 has a function of estimating at least a probability distribution of the current transmission latencies, using the transmission latency features calculated by the transmission latency preprocessing unit 111 and a transmission latency model built in advance, and outputting the probability distribution as the transmission latency distribution information. Examples of the transmission latency distribution information can include information except the probability distribution, such as a current or past mode in a hidden Markov model to be described later. Although various models can be used for the transmission latency model unit 112, the hidden Markov model (hereinafter abbreviated as the “HMM”) will be described as an example transmission latency model in this disclosure.

The HMM is a built probability model in which each mode (a state) that outputs a sequence that follows a discrete or continuous probability distribution transitions according to a transition probability defined between the modes. The probability distribution corresponding to each of the modes in the HMM will be referred to as an output distribution.

The output of the HMM and transition between the modes will be described. For example, when the HMM is in a mode A at a certain time, a sequence that follows a probability distribution of the mode A is output. The mode may transition to another mode according to a certain transition probability, and a probability distribution of the output may be changed. For example, when the mode A transitions to a mode B, a sequence corresponding to a probability distribution of the mode B is output in a time segment in the mode B. Since it is not possible to directly observe in which mode the HMM currently is but only the output sequence is observed, the model is named “hidden”.

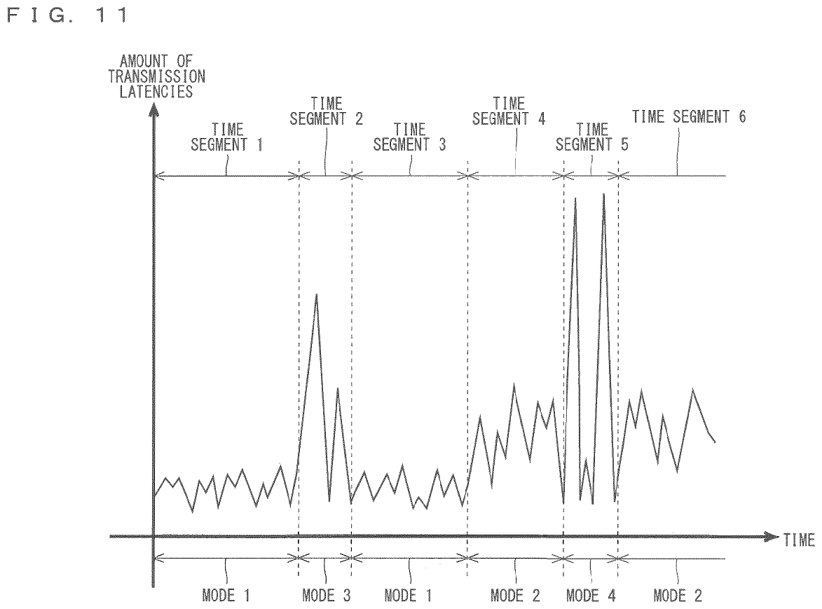

Next, the cause why transmission latencies can be modeled by the HMM will be described with reference to FIG. 11. FIG. 11 illustrates an example time series of transmission latencies. FIG. 11 illustrates sequences of times in the horizontal axis and the amounts of transmission latencies in the vertical axis, which can be easily obtained using the output of the transmission latency measurement unit 1013.

When, for example, a dedicated line is not used, the transmission latencies typically do not take constant values but always take various values. FIG. 11 illustrates such a state, and clarifies that how the transmission latencies vary is changed for each time segment. In FIG. 11, how the transmission latencies vary is equivalent between time segments 1 and 3 or between time segments 4 and 6, and time segments 2 and 5 are clearly segments in which large transmission latencies easily occur.

Assuming that the sequence of transmission latencies are output according to the HMM, modes of the time segments having the same tendency in how the transmission latencies vary can be equated. In other words, the time segments 1 and 3, and the time segments 2 and 4 can be regarded having identical modes of a mode 1 and a mode 2, respectively. Similarly, the time segment 2 and the time segment 5 can be regarded as a mode 3 and a mode 4, respectively.

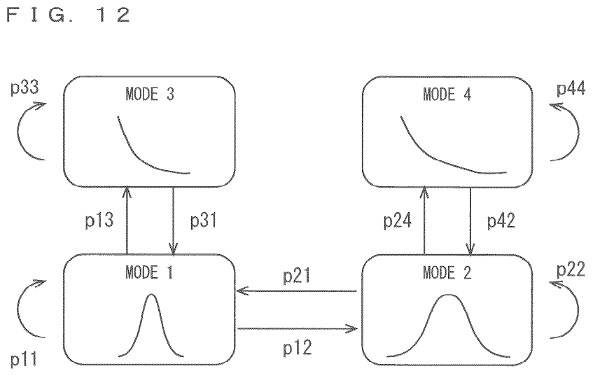

When these transmission latencies are represented by the HMM, they can be modeled as illustrated in FIG. 12. FIG. 12 illustrates the HMM having four modes, and respective latency modes can be represented as below.
A mode 1: a mode with small variance
A mode 2: a mode with large variance
A mode 3: a mode with a small burst
A mode 4: a mode with a large burst

Note that these distributions are merely imaginary, and actual communication latencies do not take a negative value, unlike a normal distribution.

In FIG. 12, pᵢⱼ (i=1, 2, 3, 4, j=1, 2, 3, 4) is a transition probability from a mode 1 at a transition source to a mode j at a transition destination. For example, when a transition source mode is 1, p11, p12, and p13 represent a transition probability from the mode 1 to the mode 1, a transition probability from the mode 1 to the mode 2, and a transition probability from the mode 1 to the mode 3, respectively. The same holds true for the modes 2, 3, and 4.

In this manner, the transmission latencies can be modeled by the HMM as an example transmission latency model.

The view of the Inventors on the cause why the transmission latencies have such a model is as follows. Path control is performed in a typical network so that a packet that is a unit of data to be transmitted and received is efficiently delivered to an accurate destination with high reliability. This path control may change a transmission path of the packet. Transition of a mode can be interpreted as representation of a condition of switching the transmission path. Although such path control is less frequently performed in a small-scaled network, the frequency of switching between transmission paths is high and changes in how the transmission latencies vary are significant in a large-scaled network. Switching between transmission paths in such a manner can be interpreted as switching between the modes.

Since use of the aforementioned model clarifies to which mode the current mode easily transitions to, the accuracy of planning an action will be improved. The modes 1 to 4 may be referred to as latency modes 1 to 4.

For example, when p11=80%, p12=19%, and p13=1% in the mode 1, the mode 1 hardly transitions to the mode 3 with a burst. Thus, a risk of a transmission latency can be regarded as being small.

Although the aforementioned HMM is a non-hierarchical hidden Markov model, for example, a hierarchical hidden Markov model in which the HMM has been hierarchically organized can be used as a more precise transmission latency model. Both of the non-hierarchical hidden Markov model and the hierarchical hidden Markov model can predict a transmission latency with high accuracy.

### [Method of Creating HMM Using Prior Information]

Although what is described above is that the transmission latency distribution estimation unit 1001 obtains the transmission latency information online from the transmission latency measurement unit 1013 and the transmission latency model unit 112 creates the HMM, the transmission latency model unit 112 can create the HMM based on the transmission latency information obtained by the transmission latency measurement unit 1013 in advance.

In other words, sequence data obtained for each certain duration, e.g., 1 hour, obtained periodically, e.g., at intervals of 0.01 second, or obtained non-periodically is defined as one set, and a plurality of the sets is obtained. The plurality of data sets obtained is defined as “prior information”.

For example, a time interval, for example, approximately one second is defined for the obtained data sets. Amounts in which a mode of transmission latencies can be estimated at the time intervals, such as an average, variance, and, the maximum value, and the minimum value are defined as transmission latency features. The transmission latency features can be defined as the “prior information”. The modes are categorized for each of the transmission latency features by a method such as clustering. This operation is performed on the plurality of data sets to obtain, for example, transition probabilities between the modes, and an output distribution of the modes. This can complete the final HMM.

The transmission latency information obtained online from the transmission latency measurement unit 1013 when the first mobile object 100 is actually controlled is defined as “posterior information” to be distinguished from the prior information. The posterior information means transmission latency information to be obtained when the remote control apparatus 1000 remotely controls the first mobile object 100. Creating the HMM based on the prior information can shorten the time required to create the HMM. Creating the HMM based on the posterior information can create the HMM that greatly matches the reality. A method of creating the HMM based on the posterior information will be described in Embodiment 3.

### [Mobile Object Action Planning Unit]

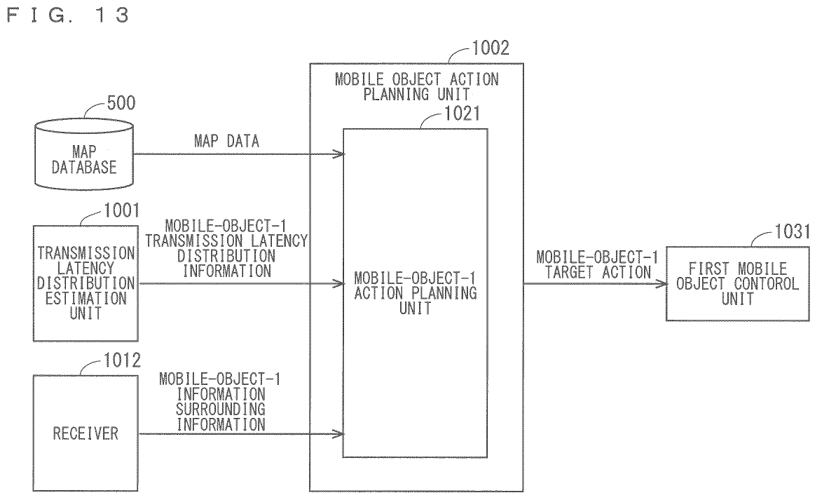

FIG. 13 is a block diagram illustrating an example configuration of the mobile object action planning unit 1002. In this example, the mobile object action planning unit 1002 includes a mobile-object-1 action planning unit 1021. The map data around the first mobile object 100 which has been obtained from the map database 500, and the mobile-object-1 information and surrounding information which have been obtained from the network NW through the receiver 1012 are input to the mobile-object-1 action planning unit 1021.

The mobile-object-1 action planning unit 1021 determines, based on these pieces of information, a planned action for normal movement of the first mobile object 100, that is, a target action such as normal movement, emergency stop, and a speed limit. Besides, the mobile-object-1 action planning unit 1021 has a function of changing the action plan, based on the mobile-object-1 transmission latency distribution information output from the transmission latency distribution estimation unit 1001.

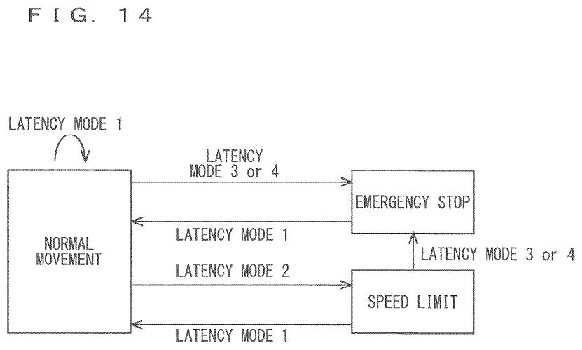

FIG. 14 schematically illustrates operations of the mobile-object-1 action planning unit 1021 for changing the target action based on the mobile-object-1 transmission latency distribution information.

When the first mobile object 100 is normally moving in the latency mode 1 in FIG. 12 and then transitions to the latency mode 2, FIG. 14 illustrates limiting the speed of the first mobile object 100 because of large variations in transmission latency. When the first mobile object 100 transitions to the latency mode 3 or 4, a latency with a burst highly probably occurs in the first mobile object 100. Thus, FIG. 14 illustrates that the first mobile object 100 is urgently stopped.

Consequently, an action can be planned in view of, for example, a situation where a transmission latency easily occurs, by changing a target action based on the mobile-object-1 transmission latency distribution information.

The target action can be represented by, for example, a target position, a target attitude, and a target path of the first mobile object 100, besides the aforementioned represented actions.

### [Mobile Object Action Planning Unit Including Risk Determination Unit]

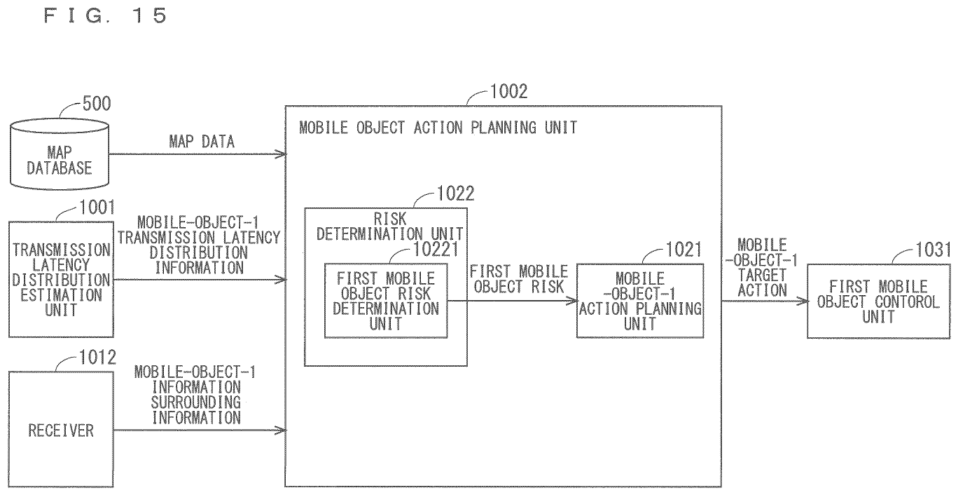

FIG. 15 is a block diagram illustrating an example configuration of the mobile object action planning unit 1002. In this example, the mobile object action planning unit 1002 includes a risk determination unit 1022 and the mobile-object-1 action planning unit 1021. The risk determination unit 1022 includes a first mobile object risk determination unit 10221.

The mobile-object-1 action planning unit 1021 plans an action using a risk computed by the first mobile object risk determination unit 10221.

The first mobile object risk determination unit 10221 numerically computes a risk to the first mobile object 100 which is determined to be a danger, such as lane departure, a collision to an obstacle, a collision to another mobile object, or a collision to a wall, using the map data, the mobile-object-1 information, the surrounding information, and the mobile-object-1 transmission latency distribution information from the transmission latency distribution estimation unit 1001, and outputs the risk as a first mobile object risk.

The first mobile object risk determination unit 10221 can compute a risk using an equation of state, dynamics models, or dynamics of a mobile object. An equation of state representing, for example, a relative relationship in position and speed between a mobile object and a surrounding object can be used.

Since this enables determination of a transmission latency and a risk such as a relative position relationship with the surrounding object and then planning an action based on the risk, the accuracy of planning the action can be improved.

The mobile-object-1 action planning unit 1021 has a function of changing a target action in the planned action for normal movement of the first mobile object 100, using the risk output from the first mobile object risk determination unit 10221.

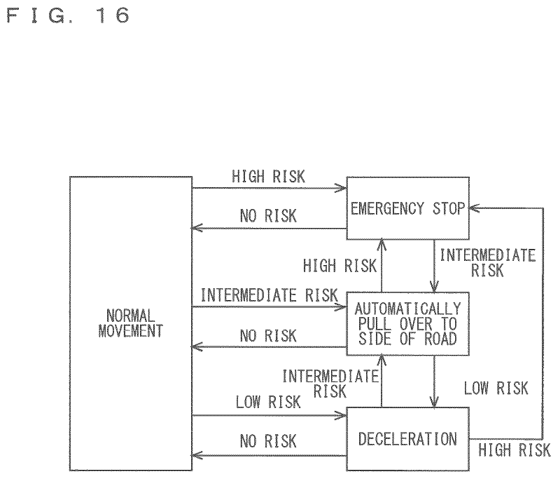

FIG. 16 schematically illustrates operations of the mobile-object-1 action planning unit 1021 for changing the target action, using the first mobile object risk from the first mobile object risk determination unit 10221.

FIG. 16 illustrates that the first mobile object 100 is urgently stopped when a risk output from the first mobile object risk determination unit 10221 becomes high (high risk) and that the first mobile object 100 is automatically pulled over to a side of a road when the risk becomes intermediate (intermediate risk).

Since the target action is determined based on not a mode of the transmission latencies but an actual risk, the accuracy of planning an action will be improved. For example, since there is no collision risk in performing remote control in a plain without any obstacle, no risk is determined even in the presence of a large latency, and an action with high accuracy can be planned.

### [Method of Calculating Transmission Latency Risk]

The method of calculating transmission latency risk will be described with reference to the latency modes of the HMM in FIG. 12.

k denotes the current time, Mₖ denotes the current mode, and Mₖ₊₁ denotes the mode of the next time. Assume that the mode of the HMM at the current time k is 1, and Mₖ=1. A probability that a transmission latency hₖ₊₁ at the next time k+1 is larger than a threshold value hₜ (>0) of a risk is calculated by Equation (1) below. An event represented by this probability is assumed to be an event A1.

$$\begin{matrix}[ Math 1 ] & \\ P ( {h}_{k + 1} > {h}_{t} \vert {M}_{k} = 1 ) = P ( {h}_{k + 1} > {h}_{t} \vert {M}_{k + 1} = 1 ) P ( {M}_{k + 1} = 1 \vert {M}_{k} = 1 ) + P ( {h}_{k + 1} > {h}_{t} \vert {M}_{k + 1} = 2 ) P ( {M}_{k + 1} = 2 {M}_{k} = 1 ) + P ( {H}_{k + 1} > {h}_{t} \vert {M}_{k + 1} = 3 ) P ( {M}_{k + 1} = 3 \vert {M}_{k} = 1 ) = P ( {h}_{k + 1} > {h}_{t} \vert {M}_{k + 1} = 1 ) {p}_{11} + P ( {h}_{k + 1} > {h}_{t} \vert {M}_{k + 1} = 2 ) {p}_{12} + P ( {h}_{k + 1} > {h}_{t} \vert {M}_{k + 1} = 3 ) {p}_{13} & ( 1 )\end{matrix}$$

Here, assuming that F₁ denotes a cumulative distribution function of an output distribution of the mode 1, P(hₖ₊₁>hₜ|Mₖ₊₁=1) is obtained from Equation (2) below. The same holds true for the other modes.

$$\begin{matrix}[ Math 2 ] & \\ P ( {h}_{k + 1} > {h}_{t} \vert {M}_{k + 1} = 1 ) = 1 - {F}_{1} ( {h}_{t} ) & ( 2 )\end{matrix}$$

Assuming that a probability that the event A1 occurs is regarded as a risk, when the risk is higher than or equal to a predetermined percentage, an action of, for example, emergency stop is planned due to the high risk.

Although the transmission latency risk at the time k+1 is calculated herein, the transmission latency risk after the time k+1, such as the time k+2, k+3, . . . can also be calculated by performing the same calculation.

Although the calculation with the transmission latency model using the HMM is described above, the calculation can be similarly performed using other probability models.

### [Method of Calculating Risk Based on Dynamics Models]

Risks except the transmission latency risk can be computed using, for example, dynamics models. Thus, risks of lane departure, a collision to an obstacle, a collision to another mobile object, and a collision to a wall can be calculated as described above. A method of calculating a risk of lane departure using dynamics models will be described with reference to FIG. 3 previously described.

Assuming that e_{y} and e_{θ} denote a lateral deviation and an angle of deviation, respectively, of the first mobile object 100 with respect to the target path TR represented by the absolute coordinate system with the X- and Y-axes as illustrated in FIG. 3, a continuous-time state equation of the first mobile object 100 in a lateral direction can be represented by Equation (3) below.

$$\begin{matrix}[ Math 3 ] & \\ \frac{d}{dt} [ \begin{matrix}{e}_{y} \\ {e}_{{y}^{*}} \\ {e}_{θ} \\ {e}_{{θ}_{*}}\end{matrix} ] = [ \begin{matrix}0 & 1 & 0 & 0 \\ 0 & - \frac{2 {C}_{f} + 2 {C}_{r}}{{mv}_{x}} & \frac{2 {C}_{f} + 2 {C}_{r}}{m} & \frac{- 2 {C}_{f} {L}_{f} + 2 {C}_{r} {L}_{r}}{{mv}_{x}} \\ 0 & 0 & 0 & 1 \\ 0 & - \frac{2 {C}_{f} {L}_{f} + 2 {C}_{r} {L}_{r}}{{I}_{z} {v}_{x}} & \frac{2 {C}_{f} {L}_{f} + 2 {C}_{r} {L}_{r}}{{I}_{z}} & - \frac{2 {C}_{f} {L}_{f}^{2} + 2 {C}_{r} {L}_{r}^{2}}{{I}_{z} {v}_{x}}\end{matrix} ] [ \begin{matrix}{e}_{y} \\ {e}_{{y}^{*}} \\ {e}_{θ} \\ {e}_{{θ}^{*}}\end{matrix} ] + [ \begin{matrix}0 \\ \frac{2 {C}_{f}}{m} \\ 0 \\ \frac{2 {C}_{f} {l}_{f}}{{I}_{z}}\end{matrix} ] & ( 3 )\end{matrix}$$

Vₓ: a vehicle speed [m/s]
δ: a steering angle [rad]
m: a mass [kg]
L_{f}: a distance between the center of gravity and a front wheel axle [m]
Lᵣ: a distance between the center of gravity and a rear wheel axle [m]
I_{z}: a moment of inertia around a yaw axle [kg·m²]
C_{f}: a front wheel cornering stiffness [N/rad]
Cᵣ: a rear wheel cornering stiffness [N/rad]
e_{y}: a lateral deviation from the center of gravity of a vehicle to a target path [m]
e_{θ}: an angle of deviation from the center of gravity of the vehicle to the target path [rad]
e_{y*}: time derivation on the lateral deviation of a mobile object
e_{θ*}: time derivation on the angle of deviation of the mobile object

A cornering stiffness is a factor of proportionality representing a relationship between a lateral force and a side slip angle which are generated in a mobile object, and is, for example, a value that is changed according to a state of a contact surface between the mobile object and a road surface, such as a dry surface, a wet surface, and an icy surface.

Such use of the dynamics model enables evaluation of a risk in the lateral direction, for example, how far the mobile object is from a target path at a future time, or how much risk for the lane departure the mobile object has.

Next, a case where a risk to the first mobile object 100 in a longitudinal direction is desirably evaluated will be described. The risk in the longitudinal direction is a risk of colliding with, for example, a forward obstacle and a wall. Equation (4) below that is a continuous-time state equation of a vehicle in the longitudinal direction can be used.

$$\begin{matrix}[ Math 4 ] & \\ \frac{d}{dt} [ \begin{matrix}{v}_{x} \\ {a}_{x}\end{matrix} ] = [ \begin{matrix}0 & 1 \\ 0 & - 1 / {T}_{a}\end{matrix} ] [ \begin{matrix}{v}_{x} \\ {a}_{x}\end{matrix} ] + [ \begin{matrix}0 \\ 1 / {T}_{a}\end{matrix} ] {u}_{a} & ( 4 )\end{matrix}$$

Equation (4) is obtained by modeling, as a first-order lag system of a time constant Tₐ, an equation of state from a target acceleration uₐ to a vehicle speed vₓ using a longitudinal direction acceleration αₓ.

The use of this Equation can evaluate a risk of how far the first mobile object 100 will proceed at the future time. Furthermore, a continuous-time state equation including a relative distance and a relative speed of a forward obstacle can be constructed. In this case, for example, a risk of colliding with the forward obstacle can be evaluated. Although this example indicates the first-order lag system, a more detailed model, for example, a second-order lag system, and a model of features of actuators to be used for controlling the mobile object in the forward and backward direction can also be used.

Thus, various risks can be evaluated using a continuous-time state equation that matches a risk desirably evaluated.

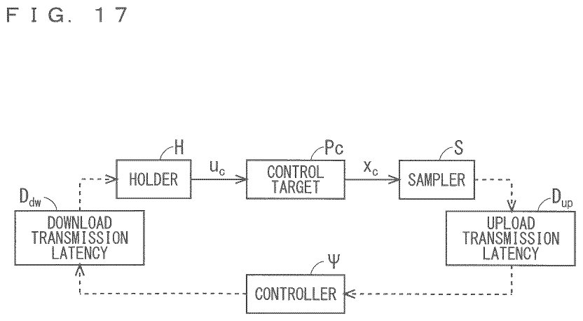

FIG. 17 is a block diagram illustrating an example control system that controls a control target under the transmission latency environment including the remote control apparatus 1000, that is, the first mobile object 100.

In FIG. 17, solid lines represent input and output of signals represented by continuous values, broken lines represent input and output of signals represented by discrete values, and x_{c} and u_{c} denote a state and an input, respectively, in a continuous time.

Since the mobile object information of the first mobile object 100 obtained by each of various sensors is a discrete value, the mobile object information corresponds to an output value of a sampler S. The mobile object information is transmitted to the remote control apparatus 1000 through the network NW. At this moment, a transmission latency, that is, an upload transmission latency D_{UP} occurs herein. The mobile object information is delayed by this upload transmission latency D_{UP}, and is input to a controller ψ. The controller ψ outputs a controlled amount computed using control gains, based on the mobile object information. This controlled amount corresponds to a controlled amount output by the controlled amount computation unit 312 of the first mobile object control unit 1031. The controlled amount is transmitted to the mobile object through the network NW. At this moment, a transmission latency, that is, a download transmission latency D_{dw} occurs herein. The controlled amount to be input to the first mobile object 100 at a certain time is kept at a constant value by a holder H until the next input. In other words, the holder H has a zero-order hold function. The zero-order held controlled amount is input to the first mobile object 100 that is a control target Pe.

Using the absolute coordinate system with the X- and Y-axes in FIG. 3, and the control system in FIG. 17, a discrete time state equation that considers transmission latencies and is constructed as an extended system with a state vector including uₖ₋₁ can be built. Here, k denotes the current time, uₖ denotes a control input at the current time, and uₖ₋₁ denotes a control input at one prior time that is represented by k−1.

Assuming hₖ denotes a random variable representing a transmission latency, xₖ₊₁ that is a state x at one advanced time is represented by Equation (5) below.

$$\begin{matrix}[ Math 5 ] & \\ {x}_{k + 1} = A ( {h}_{k} ) {x}_{k} + B ( {h}_{k} ) {u}_{k} & ( 5 )\end{matrix}$$

Furthermore, Yₖ₊₁ that is an evaluation quantity for evaluating a risk at the one advanced time is represented by Equation (6) below.

$$\begin{matrix}[ Math 6 ] & \\ {y}_{k + 1} = {Cx}_{k + 1} & ( 6 )\end{matrix}$$

Here, xₖ is a state vector obtained by adding an input uₖ₋₁ at a time k−1 to a state quantity at the time k. The state vector xₖ in Equation (3) is represented by Equation (7) below.

$$\begin{matrix}[ Math 7 ] & \\ {x}_{k} = [ {e}_{y , k} {e}_{{y}^{*} , k} {e}_{θ , k} {e}_{{θ}^{*} , k} {u}_{k - 1} ] & ( 7 )\end{matrix}$$

In Equations above, C denotes a matrix for generating yₖ₊₁ from the state vector. Furthermore, a matrix Aₖ and a matrix Bₖ at the time k are represented by Equation (8) and Equation (9), respectively, below.

$$\begin{matrix}[ Math 8 ] & \\ {A}_{k} = {e}^{{A}_{c} {h}_{k}} & ( 8 )\end{matrix}$$

$$\begin{matrix}[ Math 9 ] & \\ {B}_{k} = {\int }_{0}^{{h}_{k}} {e}^{{A}_{c} t} {B}_{c} dt & ( 9 )\end{matrix}$$

Here, each of A_{c} in Equation (8) and B_{c} in Equation (9) is a coefficient matrix of a continuous-time state equation.

Then, the matrix A and the matrix B in Equation (5) are represented by Equation (10) and Equation (11), respectively, below.

$$\begin{matrix}[ Math 10 ] & \\ A ( {h}_{k} ) = [ \begin{matrix}{A}_{k} & {B}_{k} \\ 0 & 0\end{matrix} ] & ( 10 )\end{matrix}$$

$$\begin{matrix}[ Math 11 ] & \\ B ( {h}_{k} ) = [ \begin{matrix}0 \\ I\end{matrix} ] & ( 11 )\end{matrix}$$

Furthermore, when e_{y, k+1} denotes a lateral position deviation from a target path as an evaluation quantity, the matrix C in Equation (6) can be represented by Equation (12) below.

$$\begin{matrix}[ Math 12 ] & \\ C = [ 10000 ] & ( 12 )\end{matrix}$$

The evaluation quantity yₖ₊₁ obtained in this manner is represented by Equation (13) below, using gₖ₊₁(hₖ) that is a function of the transmission latency hₖ.

$$\begin{matrix}[ Math 13 ] & \\ {y}_{k + 1} := {g}_{k + 1} ( {h}_{k} ) = C \{ A ( {h}_{k} ) {x}_{k} + B ( {h}_{k} ) {u}_{k} \} & ( 13 )\end{matrix}$$

Here, an inverse operation of the transmission latency hₖ reaching yₖ₊₁=yₜ first under given yₜ(>0) can be performed. The inverse result is written as gₖ⁻¹(yₜ).

An event in which the evaluation quantity yₖ₊₁ of the first mobile object 100 at the time k+1 is larger than yₜ(>0) is assumed to be an event A2. A probability that the event A2 occurs is considered as a risk. When it is determined at the time k that a mode at the time k−1 is the mode 1, assuming h_{A2,k} denotes the transmission latency hₖ=gₖ₊₁⁻¹(yₜ) with which the evaluation quantity yₖ₊₁ first becomes an evaluation quantity yₜ, the probability that the event A2 occurs, that is, a probability that the evaluation quantity yₖ₊₁ is larger than the evaluation quantity yₜ is represented by Equation (14) below. Calculating this in the method described in “Method of calculating transmission latency risk” can calculate the risk.

$$\begin{matrix}[ Math 14 ] & \\ P ( {y}_{k + 1} > {y}_{t} \vert {M}_{k - 1} = 1 ) = P ( {h}_{k} > {h}_{A 2 , k} \vert {M}_{k - 1} = 1 ) & ( 14 )\end{matrix}$$

A probability that the transmission latency hₖ is larger than a transmission latency h_{A2,k} and a transmission latency h_{A2,k} can be analytically or numerically calculated.

Although a method of evaluating a risk when a deviation increases to the positive side is described above, a risk when a deviation decreases to the negative side can be also evaluated in the same manner.

In another example, a risk can be an expected value y_{e, k+1} of the evaluation quantity yₖ₊₁. When it is determined at the time k that a mode at the time k−1 is the mode 1, the expected value y_{e,k+1} can be calculated by Equation (15) below.

$$\begin{matrix}[ Math 15 ] & \\ {y}_{e , k + 1} = {\int }_{- ∞}^{∞} {g}_{k + 1} ( {h}_{k} ) dF ( {h}_{k} \vert {M}_{k - 1} = 1 ) & ( 15 )\end{matrix}$$

Here, F(|) denotes a conditional cumulative distribution function. Besides the expected value, for example, variance and a higher moment of y_{e, k+1} can also be used as risks.

Although the risk at the time k+1 is calculated above, a risk after the time k+1, such as the time k+2, k+3, . . . can also be calculated by performing the aforementioned calculation, similarly to the transmission latency risk.

When the configuration of the first mobile object controller 1031 is known, for example, a control input uₖ₊₁ in the future after the time k+1 can be predicted using information on the configuration.

Since Equation (3) depends on the dynamics model of the first mobile object 100, when the technology of the present disclosure is used for another mobile object, Equation (3) will be modified according to a target mobile object and then calculated.

Although evaluation of a risk in the form of a continuous-time state equation is described above, the continuous-time state equation need not always be used. Use of an equation representing a dynamics model and dynamics such as an equation of motion can also evaluate a risk.

When a dynamics model of a mobile object is complicated, a risk such as P(yₖ₊₁>yₜ|Mₖ₋₁=1), y_{e, k+1} is not easily obtained in some cases. In such a case, the risk can be calculated by a numerical calculation method, such as Monte-Carlo methods.

### Embodiment 2

### [Overall Configuration]

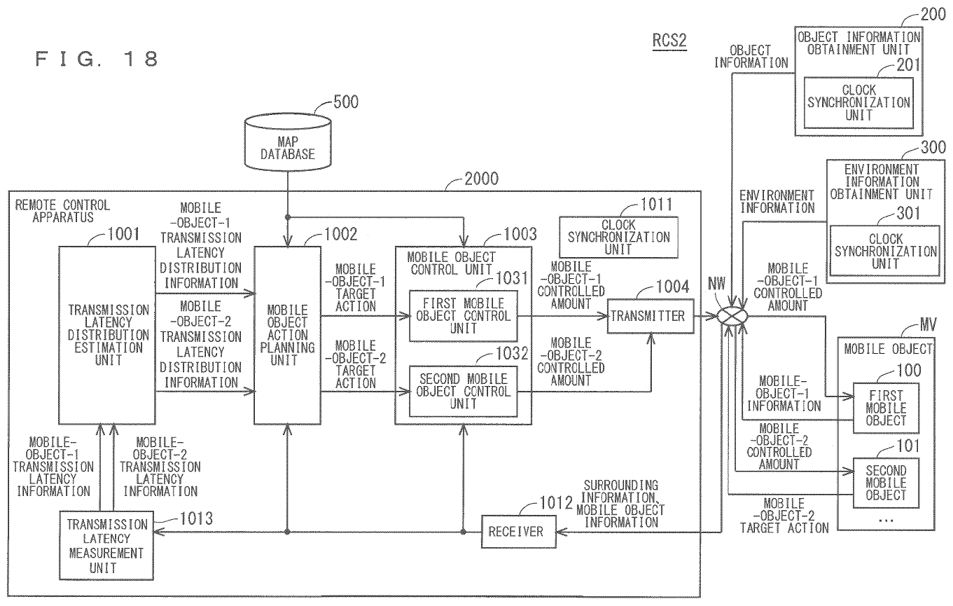

FIG. 18 is a block diagram illustrating an example configuration of a remote control apparatus 2000, and a configuration of a remote control system RCS2 for mobile objects MV to be remotely controlled through the network NW, in Embodiment 2 according to the present disclosure.

As illustrated in FIG. 18, the remote control system RCS2 has the configuration in which the mobile objects MV, the remote control apparatus 2000, the object information obtainment unit 200, and the environment information obtainment unit 300 are connected to the network NW.

The remote control apparatus 2000 according to Embodiment 2 differs from the remote control apparatus 1000 in controlling a plurality of mobile objects. The mobile object control unit 1003 includes a first mobile object control unit 1031 and a second mobile object control unit 1032. The mobile objects MV to be controlled are a first mobile object 100 and a second mobile object 101. In FIG. 18, the same reference numerals are used for the same configurations as those of the remote control apparatus 1000 described with reference to FIG. 1, and the overlapping description will be omitted.

The first mobile object 100 and the second mobile object 101 move based on the mobile-object-1 controlled amount and a mobile-object-2 controlled amount which are to be transmitted from the transmitter 1004 of the remote control apparatus 2000, and output state quantities of the mobile objects which have been detected by internal sensors including speed sensors mounted on the first mobile object 100 and the second mobile object 101, as the mobile-object-1 information and mobile-object-2 information, respectively.

The object information obtainment unit 200 includes one or more sensors in the vicinity of the first mobile object 100 and the second mobile object 101 or to be mounted on the first mobile object 100 and the second mobile object 101. The object information obtainment unit 200 obtains, as environment information, for example, a position and a speed of an obstacle around the first mobile object 100 and the second mobile object 101, such as another vehicle, a bicycle, and a pedestrian. Furthermore, the object information obtainment unit 200 can obtain, for example, a position and a speed of its own first mobile object 100 as the mobile-object-1 information, and a position and a speed of its own second mobile object 101 as the mobile-object-2 information. Here, the mobile object information is a part of the object information. The object information obtainment unit 200 transmits the mobile object information to the receiver 1012 in the remote control apparatus 2000 through the network NW. When internal sensors are installed in the first mobile object 100, these internal sensors can obtain the mobile object information. When internal sensors are installed in the second mobile object 101, these internal sensors can obtain the mobile object information. Thus, the mobile object information can be obtained from the object information obtainment unit 200 or from the first mobile object 100 and the second mobile object 101.

The environment information obtainment unit 300 includes one or more sensors to be installed in the vicinity of the first mobile object 100 and one or more sensors to be installed in the vicinity of the second mobile object 101, similarly to the object information obtainment unit 200. The environment information obtainment unit 300 obtains environment information on, for example, a traffic light and a stop line. The environment information obtainment unit 300 transmits the environment information to the receiver 1012 in the remote control apparatus 2000 through the network NW.

Next, each of the constituent elements of the remote control apparatus 2000 will be described. As illustrated in FIG. 18, the remote control apparatus 2000 includes the transmission latency distribution estimation unit 1001, the mobile object action planning unit 1002, the mobile object control unit 1003, the transmitter 1004, the clock synchronization unit 1011, the receiver 1012, and the transmission latency measurement unit 1013.

Although these elements have functions identical to those of the remote control apparatus 1000 in FIG. 1, the transmission latency measurement unit 1013 measures transmission latencies between the first mobile object 100 and the second mobile object 101, and the remote control apparatus 2000, using the clock synchronized by the clock synchronization unit 1011, and outputs, to the transmission latency distribution estimation unit 1001, the transmission latencies as mobile-object-1 transmission latency information on the first mobile object 100 and mobile-object-2 transmission latency information on the second mobile object 101.

The transmission latency distribution estimation unit 1001 outputs mobile-object-1 transmission latency distribution information on the first mobile object 100 and mobile-object-2 transmission latency distribution information on the second mobile object 101, using the mobile-object-1 transmission latency information and the mobile-object-2 transmission latency information, respectively, from the transmission latency measurement unit 1013.

When considering that the mobile objects have almost equivalent network environment and surrounding circumstances, and have almost the same tendency in transmission latency, the transmission latency measurement unit 1013 and the transmission latency distribution estimation unit 1001 equate the transmission latency information on the first mobile object 100 with the transmission latency information on the second mobile object 101, group the first mobile object 100 and the second mobile object 101 into one group, estimate common transmission latency distribution information using the transmission latency information on the first mobile object 100 or the second mobile object 101, and output the common transmission latency distribution information to the mobile object action planning unit 1002.

Consequently, the computation for estimating the transmission latency distribution is done only once, which can reduce calculation loads. The same holds true for the presence of three or more mobile objects.

The mobile object action planning unit 1002 plans actions of the first mobile object 100 and the second mobile object 101, that is, deceleration, avoiding an obstacle, stopping, changing a lane, pulling over to a side of a road, or an emergency evasive maneuver, using the map data around the first mobile object 100 which has been obtained from the map database 500, and the object information output from the object information obtainment unit 200, the environment information output from the environment information obtainment unit 300, the mobile-object-1 information output from the first mobile object 100, and the mobile-object-2 information output from the second mobile object 101 all of which have been obtained through the network NW, and the mobile-object-1 transmission latency distribution information and the mobile-object-2 transmission latency distribution information output from the transmission latency distribution estimation unit 1001, and outputs the actions as the mobile-object-1 target action of the first mobile object 100 and a mobile-object-2 target action of the second mobile object 101.

The first mobile object control unit 1031 of the mobile object control unit 1003 computes the mobile-object-1 controlled amount for allowing the first mobile object 100 to follow a target trajectory, based on the mobile-object-1 information obtained from the network NW through the receiver 1012 and the mobile-object-1 target action obtained from the mobile object action planning unit 1002.

The second mobile object control unit 1032 of the mobile object control unit 1003 computes a mobile-object-2 controlled amount for allowing the second mobile object 101 to follow a target trajectory, based on the mobile-object-2 information obtained from the network NW through the receiver 1012 and the mobile-object-2 target action obtained from the mobile object action planning unit 1002.

### [Mobile Object Action Planning Unit]

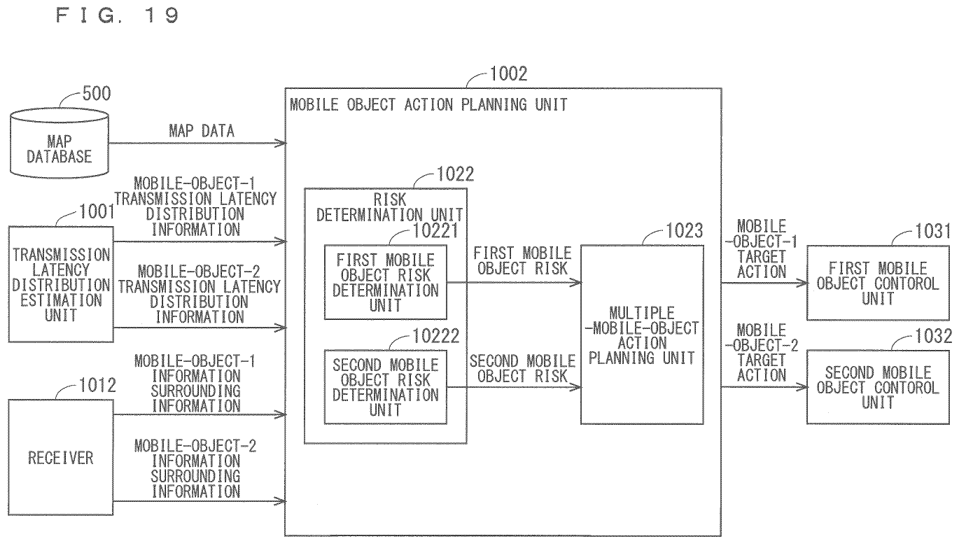

FIG. 19 is a block diagram illustrating an example configuration of the mobile object action planning unit 1002. In this example, the mobile object action planning unit 1002 includes the risk determination unit 1022 and a multiple-mobile-object action planning unit 1023. The risk determination unit 1022 includes the first mobile object risk determination unit 10221 and a second mobile object risk determination unit 10222.

The multiple-mobile-object action planning unit 1023 plans actions, using a first mobile object risk computed by the first mobile object risk determination unit 10221 and a second mobile object risk computed by the second mobile object risk determination unit 10222.

The first mobile object risk determination unit 10221 numerically computes a risk to the first mobile object 100 which is determined to be a danger, such as lane departure, a collision to an obstacle, a collision to another mobile object, or a collision to a wall, using the map data, the mobile-object-1 information, the surrounding information, and the mobile-object-1 transmission latency distribution information from the transmission latency distribution estimation unit 1001, and outputs the risk as the first mobile object risk.

The second mobile object risk determination unit 10222 numerically computes a risk to the second mobile object 101 which is determined to be a danger, such as lane departure, a collision to an obstacle, a collision to another mobile object, or a collision to a wall, using the map data, the mobile-object-2 information, the surrounding information, and the mobile-object-2 transmission latency distribution information from the transmission latency distribution estimation unit 1001, and outputs the risk as the second mobile object risk.

Since the risks are computed in the same manner by the risk determination unit 1022 of the mobile object action planning unit 1002 in FIG. 15, the description will be omitted.

### [Multiple-Mobile-Object Action Plans]

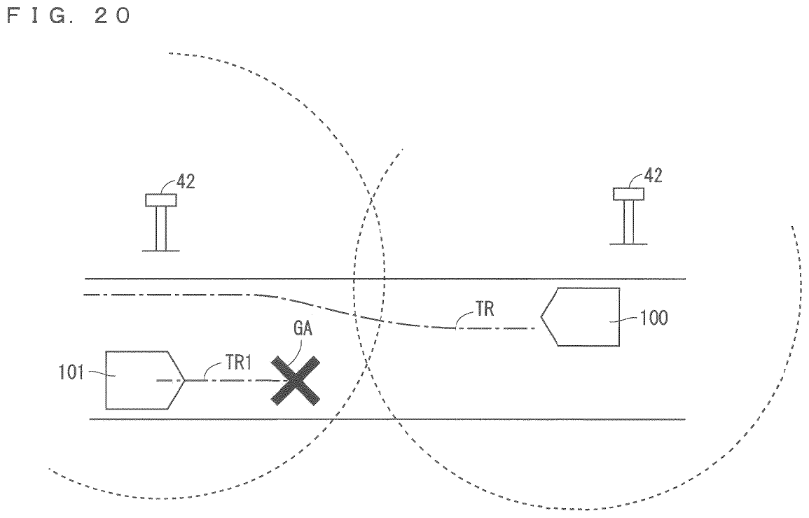

Multiple-mobile-object action plans to be created by the multiple-mobile-object action planning unit 1023 of the mobile object action planning unit 1002 when the remote control apparatus 2000 controls a plurality of mobile objects will be described with reference to FIG. 20.

FIG. 20 illustrates a planned action when the first mobile object 100 and the second mobile object 101 pass each other. Two of the external sensors 42 are disposed on a side of a road along which the first mobile object 100 moves. The two external sensors 42 are disposed at a distance in which detection ranges indicated by broken lines partly overlap, and cover the first mobile object 100 and the second mobile object 101 that are located distant from each other.

Here, it is assumed that the second mobile object 101 is in a mode in which the transmission latency is prone to burst and the first mobile object 100 is in a mode with small variance. Here, the multiple-mobile-object action planning unit 1023 determines the risk to the second mobile object 101 to be high, and generates a target path TRI indicated by alternate long and short dash lines in FIG. 20 to cause the second mobile object 101 to stop at a stop position GA. When determining the risk to the first mobile object 100 to be low, the multiple-mobile-object action planning unit 1023 causes the first mobile object 100 to continue to proceed straight. However, when determining that the first mobile object 100 still has a risk, the multiple-mobile-object action planning unit 1023 generates a target path TRI indicated by alternate long and short dash lines in FIG. 20 to instruct the first mobile object 100 to take an action of slightly moving away from the second mobile object 101.

As such, the multiple-mobile-object action planning unit 1023 instructs the respective mobile objects to take actions for reducing the overall risks, in view of relative positions, speeds, and transmission latency distributions of the mobile objects. This enables the plurality of mobile objects to efficiently operate.

Future positions of the mobile objects can be predicted using target trajectories of the mobile objects, and risks can be calculated.

Although the multiple-mobile-object action plans are actions of a plurality of mobile objects which are simultaneously planned, the actions can be planned independently.

### Embodiment 3

### [Overall Configuration]

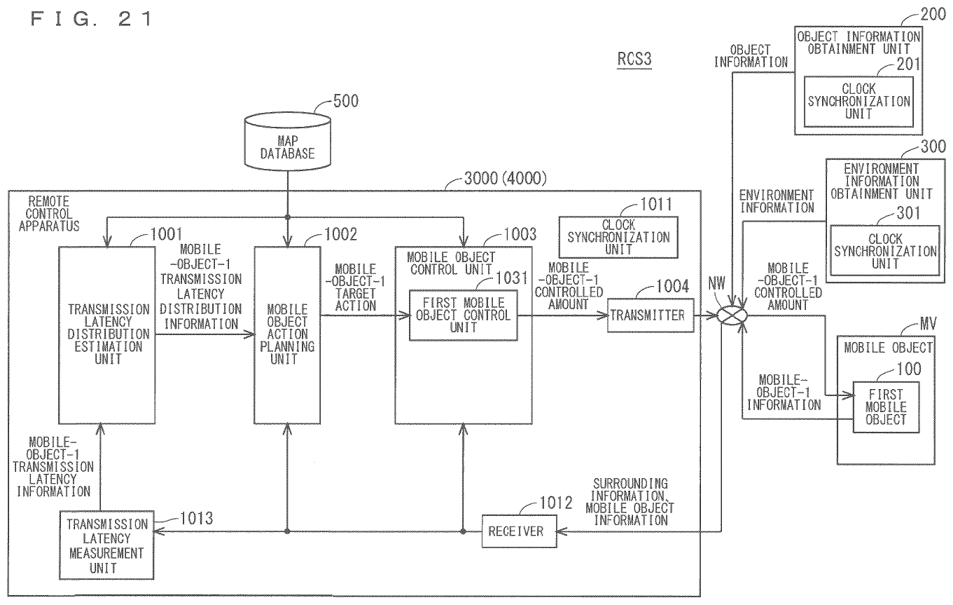

FIG. 21 is a block diagram illustrating an example configuration of a remote control apparatus 3000, and a configuration of a remote control system RCS3 for the mobile object MV to be remotely controlled through the network NW, in Embodiment 3 according to the present disclosure.

As illustrated in FIG. 21, the remote control system RCS3 has the configuration in which the mobile object MV, the remote control apparatus 3000, the object information obtainment unit 200, and the environment information obtainment unit 300 are connected to the network NW.

The remote control apparatus 3000 according to Embodiment 3 differs from the remote control apparatus 1000 in FIG. 1 in that not only the transmission latency information from the transmission latency measurement unit 1013 but also the map data from the map database 500, and the surrounding information and the mobile object information which have been obtained through the network NW are input to the transmission latency distribution estimation unit 1001. In FIG. 21, the same reference numerals are used for the same configurations as those of the remote control apparatus 1000 described with reference to FIG. 1, and the overlapping description will be omitted.

Although the mobile object MV is limited to the first mobile object 100 in FIG. 21 to facilitate the description, a plurality of mobile objects can be control targets, similarly to the remote control apparatus 2000 in FIG. 18. Here, the transmission latency distribution estimation unit 1001 receives information on the plurality of mobile objects from the receiver 1012, and outputs the transmission latency distribution information on each of the mobile objects to the mobile object action planning unit 1002.

When considering that the mobile objects have almost equivalent network environment and surrounding circumstances, and have almost the same tendency in transmission latency, the transmission latency measurement unit 1013 and the transmission latency distribution estimation unit 1001 equate the transmission latency information on the first mobile object 100 with the transmission latency information on the second mobile object 101, group the first mobile object 100 and the second mobile object 101 into one group, estimate common transmission latency distribution information using the transmission latency information on the first mobile object 100 or the second mobile object 101, and output the common transmission latency distribution information to the mobile object action planning unit 1002. Thus, the computation for estimating the transmission latency distribution is done only once, which can reduce calculation loads.

### [Transmission Latency Distribution Estimation Unit]

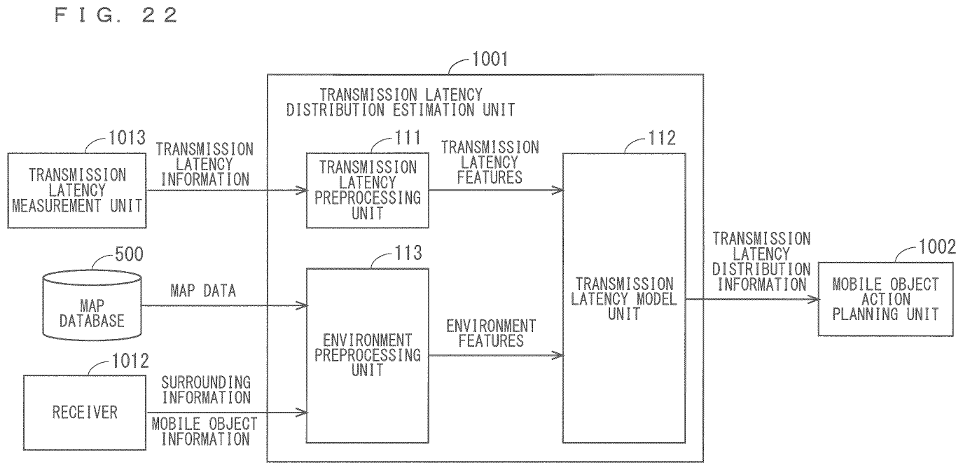

FIG. 22 is a block diagram illustrating an example configuration of the transmission latency distribution estimation unit 1001. In this example, the transmission latency distribution estimation unit 1001 includes the transmission latency preprocessing unit 111, the transmission latency model unit 112, and an environment preprocessing unit 113.

The transmission latency preprocessing unit 111 has a function of transforming the transmission latency information from the transmission latency measurement unit 1013 into transmission latency features to be referred to by the transmission latency model unit 112.

The transmission latency model unit 112 has been modeled in advance using the transmission latency features calculated by the transmission latency preprocessing unit 111, and computes the transmission latency distribution information with reference to the transmission latency features and environment features.

A transmission latency is influenced by, for example, a position of a mobile object, a time period, and a relative position of a surrounding environment, that is, a surrounding structure with respect to the mobile object, and these pieces of information can be obtained from the map data and the mobile object information.

The environment preprocessing unit 113 calculates features on environment information except the transmission latency information. In other words, the environment preprocessing unit 113 computes, from the mobile object information and the map data, environment features that characterize the time period, the position of the mobile object, and the surrounding environment.

The transmission latency features are directly obtained from a sequence of transmission latencies, whereas the environment features representing surrounding circumstances of a mobile object are computed from physically measurable values including the current time, a radio wave condition around the mobile object, the presence or absence of a surrounding structure, a distance between the surrounding structure and the mobile object, a conductor around the mobile object, an obstacle, field intensity, and traffic. The environment preprocessing unit 113 computes the environment features, using the map data, the mobile object information, and the surrounding information.

For example, if a building is located near a mobile object, the position of the building can be detected from the map data, and the position of the mobile object can be detected from the GNSS. Thus, the relative distance between the building and the mobile object can be converted into numbers, which will be used as an environment feature. Since, for example, the field intensity can be detected from an antenna and a receiver, the field intensity can be used as an environment feature.

As previously described, how the transmission latency varies is changed according to switching between transmission paths. Besides, the transmission latency may occur due to load conditions on the network NW, such as a condition of a line user, traffic, and characteristics of a router. Since a mobile object moves, the transmission latency may occur due to influences such as the presence or absence of an obstacle on a radio propagation route, jamming, and the presence or absence of a conductor around the mobile object. The confluence of these factors probably produces the final transmission latency.

Inputting the environment features representing such circumstances into a transmission latency model can create a transmission latency model with higher accuracy, and estimate the transmission latency distribution. Consequently, this produces an advantage of increasing the accuracy of estimating a risk and planning an action.

The transmission latency model in Embodiment 3 is structured, specifically, such that the transition probability between modes represented by pᵢⱼ (i=1, 2, 3, 4, j=1, 2, 3, 4) in FIG. 12 is changed according to the environment features. For example, when a mobile object moves in a place with many structures around, for example, a building, by which radio waves are refracted or blocked, the transition probability is increased so that the mobile object easily transitions to a mode of larger transmission latencies. Alternatively, since traffic decreases at nighttime, modeling, such as reducing a transition probability to prevent the mobile object from transitioning to the mode of larger transmission latencies is conceivable.

The transmission latency model unit 112 in Embodiment 3 also refers to the environment features computed by the environment preprocessing unit 113, For example, when selecting a field intensity as an environment feature, the transmission latency model unit 112 can estimate the current mode in HMM by referencing the field intensity. Thus, the transmission latency model unit 112 outputs the probability distribution in the mode, as the transmission latency distribution information.

### Embodiment 4

### [Transmission Latency Distribution Estimation Unit]

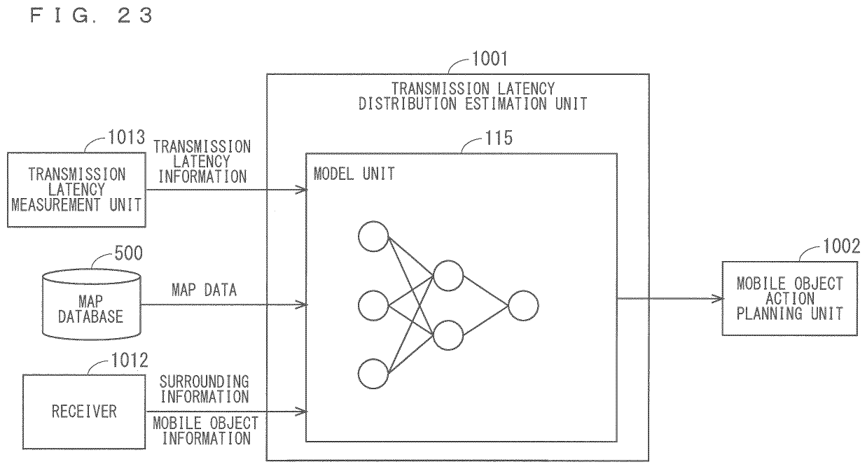

FIG. 23 is a block diagram illustrating an example configuration of the transmission latency distribution estimation unit 1001 of a remote control apparatus 4000 in Embodiment 4 according to the present disclosure. In this example, the transmission latency distribution estimation unit 1001 includes a model unit 115. Since the configurations except the transmission latency distribution estimation unit 1001 are identical to those of the remote control apparatus 3000 according to Embodiment 3 in FIG. 21, the overlapping description will be omitted assuming that the overall configurations are identical to those in FIG. 21.

Upon receipt of the transmission latency information from the transmission latency measurement unit 1013, the map data from the map database 500, and the surrounding information and the mobile object information which have been obtained through the network NW, the model unit 115 computes the transmission latency distribution information through machine learning.

In recent years, technologies on machine learning using artificial intelligence (AI) with deep learning technology at the top have significantly been advanced.

In Embodiment 4, a transmission latency model is learned using the technologies on machine learning, so that the transmission latency distribution information can be obtained with high accuracy using the obtained learned model.

The transmission latency distribution estimation unit 1001 in FIG. 23 is configured to output the transmission latency distribution information online, using the learned model that has been learned through machine learning. When learning the transmission latency model, first, the transmission latency distribution estimation unit 1001 needs to obtain learning data. To obtain the learning data, the transmission latency distribution estimation unit 1001 obtains the mobile-object-1 transmission latency information from the transmission latency measurement unit 1013, and the surrounding information and the mobile object information which have been obtained through the network NW, and stores such pieces of information as data sets while the first mobile object 100 is moving. The model unit 115 can be learned using the stored data sets and the map database 500.

Learning methods using the transmission latency model as an HMM model have been researched well mainly in the speech recognition field. The HMM model can be learned using the methods. When learning a more typical transmission latency model is desired, learning using a machine learning method with long-short time memory (LSTM) in which a time series is learned is possible.

The transmission latencies can include at least an amount of transmission latencies, an average value of transmission latencies in a predefined time segment, variance of transmission latencies, or the maximum value or the minimum value of transmission latencies.

The surrounding information can include at least the time, a radio wave condition around a mobile object, the presence or absence of a structure around the mobile object, a distance between the structure and the mobile object, a conductor and an obstacle around the mobile object, field intensity, weather, and traffic.

The map data can include at least a shape of a road around the mobile object, and a position and a shape of a surrounding structure.

In the machine learning, learning is possible if there is a correlation between an input and an output. Thus, inputting the transmission latency features, the environment features, and the map data into the model unit 115 allows output of the transmission latency distribution information. For example, “Speech recognition system using free software (2nd edition)”, Masahiro Araki (author), MORIKITA PUBLISHING CO., LTD. discloses an HMM learning method through deep learning.

### [Hardware Configuration]

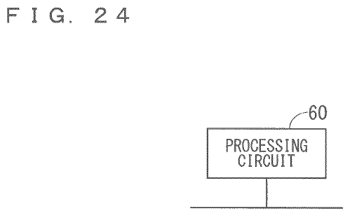

Each of the constituent elements of the remote control apparatuses 1000 to 4000 according to Embodiments 1 to 4 can be configured using a computer, and is implemented by causing the computer to execute a program. In other words, the remote control apparatuses 1000 to 4000 can be implemented by, for example, a processing circuit 60 illustrated in FIG. 24. A processor such as a central processing unit (CPU) or a digital signal processor (DSP) is applied to the processing circuit 60. The processing circuit 60 causes the program stored in a storage to implement functions of each of the constituent elements.

The processing circuit 60 may be dedicated hardware. When the processing circuit 60 is dedicated hardware, it corresponds to, for example, a single circuit, a composite circuit, a programmed processor, a parallel-programmed processor, an application-specific integrated circuit (ASIC), a field-programmable gate array (FPGA), or any combinations thereof.

Each function of the constituent elements of the remote control apparatuses 1000 to 4000 can be implemented by a separate processing circuit, or the functions may be collectively implemented by a single processing circuit.

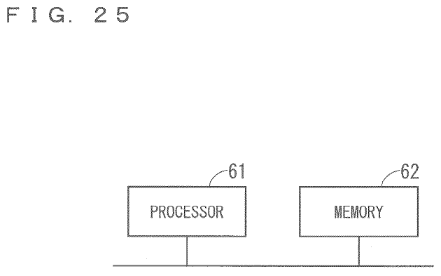

FIG. 25 illustrates a hardware configuration when the processing circuit 60 is configured using a processor. In this case, the functions of the constituent elements of the remote control apparatuses 1000 to 4000 are implemented by any combinations with software, etc. (software, firmware, or the software and the firmware). For example, the software is described as a program, and stored in a memory 62. A processor 61 functioning as the processing circuit 60 implements the functions of each of the constituent elements by reading and executing the program stored in the memory 62 (a storage). In other words, this program causes a computer to execute procedures and methods of operations of the constituent elements of the remote control apparatuses 1000 to 4000.

Here, examples of the memory 62 include a non-volatile or volatile semiconductor memory such as RAM, ROM, a flash memory, an erasable programmable read-only memory (EPROM), and an electrically erasable programmable read-only memory (EEPROM), hard disk drive (HDD), a magnetic disk, a flexible disk, an optical disk, a compact disc, a minidisc, a Digital Versatile Disc (DVD), a drive device thereof, and further any storage medium to be used in the future.

What is described is that, for example, one of hardware and software implements the functions of each of the constituent elements of the remote control apparatuses 1000 to 4000. However, the configuration is not limited to such but part of the constituent elements of the remote control apparatuses 1000 to 4000 can be implemented by dedicated hardware, and another part thereof can be implemented by software. For example, the processing circuit 60 functioning as the dedicated hardware can implement the part of the constituent elements, and the processing circuit 60 functioning as the processor 61 can implement the functions of another part of the constituent elements through reading and executing a program stored in the memory 62.

As described above, the remote control apparatuses 1000 to 4000 can implement each of the functions by hardware, software, etc., or any combinations of these.

Although the present disclosure is described in detail, the foregoing description is in all aspects illustrative and does not restrict the present disclosure. It is therefore understood that numerous modifications and variations that have not yet been exemplified can be devised without departing from the scope of the present disclosure.

Embodiments of the present disclosure can be freely combined, and appropriately modified or omitted within the scope of the disclosure.

1. A remote control apparatus controlling at least one mobile object through a transmission path including at least a network, the apparatus comprising:
transmission latency distribution estimation circuitry to estimate transmission latency distribution information including a probability distribution of transmission latencies in the transmission path and a mode corresponding to the probability distribution; and
action planning circuitry to plan an action of the at least one mobile object which corresponds to the mode, based on the transmission latency distribution information, and outputs the action as a target action,
wherein the transmission latency distribution estimation circuitry estimates the probability distribution of the transmission latencies, using a transmission latency model based on the mode of the transmission latencies.

2. The remote control apparatus according to claim 1,
wherein the transmission latency distribution estimation circuitry estimates the transmission latency distribution information, based on transmission latency information obtained in advance or online.

3. The remote control apparatus according to claim 1, further comprising:
control circuitry to compute a controlled amount for controlling the at least one mobile object so that the at least one mobile object implements the target action output by the action planning circuitry.

4. The remote control apparatus according to claim 1,
wherein the action planning circuitry plans the action to correspond to the mode of the transmission latencies, and outputs the action as the target action.

5. The remote control apparatus according to claim 2,
wherein the transmission latency distribution estimation circuitry estimates the transmission latency distribution information, based on the transmission latency information and environment features that characterize a surrounding environment of the at least one mobile object.

6. The remote control apparatus according to claim 1,
wherein the transmission latency distribution estimation circuitry learns and builds the transmission latency model through machine learning.

7. The remote control apparatus according to claim 1,
wherein the transmission latency distribution estimation circuitry uses a hierarchical or non-hierarchical hidden Markov model as the transmission latency model.

8. The remote control apparatus according to claim 1, wherein:
the at least one mobile object comprises a plurality of mobile objects, and
the action planning circuitry plans the action for each of the plurality of mobile objects, and outputs the actions as the target actions.

9. The remote control apparatus according to claim 8,
wherein when equating respective pieces of the transmission latency distribution information of the plurality of mobile objects, the transmission latency distribution estimation circuitry groups the plurality of mobile objects, and estimates common transmission latency distribution information using one of the pieces of the transmission latency distribution information.

10. The remote control apparatus according to claim 1,
wherein the action planning circuitry determines a risk to the at least one mobile object using an equation of state representing a relative relationship in position and speed between the at least one mobile object and a surrounding object, based on state information on the at least one mobile object and surrounding information on surroundings of the at least one mobile object as well as the transmission latency distribution information, and changes the target action based on the determined risk.

11. A remote control system, comprising:
the remote control apparatus according to claim 1;
the network; and
the at least one mobile object,
wherein the at least one mobile object includes control circuitry that implements the target action output by the action planning circuitry of the remote control apparatus, and
the remote control apparatus transmits the target action output by the action planning circuitry to the at least one mobile object through the network, and causes the at least one mobile object to implement the target action.

12. A remote control system, comprising:
the remote control apparatus according to claim 3;
the network; and
the at least one mobile object,
wherein the remote control apparatus transmits the controlled amount computed by the control circuitry to the at least one mobile object through the network, and causes the at least one mobile object to implement the target action output by the action planning circuitry.

13. (canceled)
